(19) United States
(12) Patent Application Publication
(10) Pub. No.: US 2008/0268272 A1
(43) Pub. Date: Oct. 30, 2008

(54) Polymeric Compositions

(76) Inventor: Eric Jourdain, Rhode Saint Genese (BE)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 11/915,760

(22) PCT Filed: May 24, 2006
(86) PCT No.: PCT/EP2006/005067

§ 371 Date: Nov. 28, 2007

(30) Foreign Application Priority Data
Jun. 3, 2005 (GB) 0511319.6

(51) Int. Cl. B32B 27/32; C08L 23/00

(52) U.S. Cl. 428/523; 525/55; 525/240

(57) ABSTRACT

The invention relates to composite articles comprising first and second members, in which the first member comprises an elastomeric material and the second member comprises a material which comprises a modifier and a thermoplastic polymer.

This invention relates to polymeric compositions, especially plasticized polymeric compositions, and their uses, especially in laminates. The invention also relates to laminates in which at least one layer comprises the plasticized polymeric compositions of the invention.

It is frequently desirable to provide an article having a property or characteristic at or on the or a surface differing in some way from that of the some or all of the remainder of the article. Such surface property or characteristic may be, for example, colour, flexibility, coefficient of friction, static or dynamic, UV stability, resistance to abrasion, propensity to crack under flex, surface texture, ageing, and tendency to exude components on ageing. For instance, a layer of a material having a low sliding coefficient such as polyethylene may be applied to an elastomeric substrate in order to improve the surface properties of the article. One example is the use of a polyethylene slip coat in automobile weatherseals. The slip coat reduces the friction between the window glass and the weatherseal. However, there is a desire to improve the properties of the surface material to further enhance performance.

For polyethylene-type resins, the most common approach to improving flexibility and toughness is to lower the crystallinity (and therefore the density) by addition of comonomer. Traditional approaches to achieve low melt viscosity are lowering the molecular weight and broadening the molecular weight distribution of the resin. However, both approaches can have detrimental effects on the final physical properties of the polyolefin article, such as lower puncture resistance or lower impact resistance. It would be advantageous in a fabrication environment to be able to continuously vary these parameters to match changing needs, instead of choosing between discrete polyethylene types sold by density, melt index, and composition.

Addition of a plasticizer or other amorphous substance to a polyolefin is one way to attempt to address these needs. For example, polyolefins and elastomers are blended with materials such as mineral oils which contain aromatic and/or other functional groups. Typically, addition of mineral oil also lowers the melt viscosity because the mineral oil itself has a viscosity well below that of the polyolefin.

Addition of compounds like mineral oils tend to improve the flexibility of a polyolefin, which identifies such compounds as “plasticizers” under the commonly accepted definition; that is, a substance that improves the flexibility, workability, or distensibility of a plastic or elastomer. Mineral oils are also often used as extenders, as well as for other purposes, in polyolefins. However, use of these additive compounds typically does not preserve the optical properties (e.g., color and or transparency) of the polyolefin, among other things. The melting point of the polyolefin is also typically not preserved, which reduces the softening point and upper use temperature of the composition. In addition, such additive compounds often have high pour points (greater than −20° C., or even greater than −10° C.), which results in little or no improvement in low temperature toughness of the polyolefin.

To improve the low temperature characteristics, it is customary to choose lower molecular weight, amorphous compounds as plasticizers. Low molecular weight compounds are also chosen for their low viscosity, which typically translates into lower melt viscosity and improved processibility of the polyolefin composition. Unfortunately, this choice often leads to other problems. For example, all or some of the additive can migrate to a surface and evaporate at an unacceptably high rate, which results in deterioration of properties over time. If the flash point is sufficiently low (e.g., less than 200° C.), the compound can cause smoking and be lost to the atmosphere during melt processing. It can also leach out of the polyolefin and impair food, clothing, and other articles that are in contact with the final article made from the plasticized polyolefin. It can also cause problems with tackiness or other surface properties of the final article.

Another shortcoming of typical additive compounds is that they often contain a high (greater than 5 wt %) degree of functionality due to carbon unsaturation and/or heteroatoms, which tends to make them reactive, thermally unstable, and/or incompatible with polyolefins, among other things. Mineral oils, in particular, consist of thousands of different compounds, many of which are undesirable for use in polyolefins due to molecular weight or chemical composition. Under moderate to high temperatures these compounds can volatilize and oxidize, even with the addition of oxidation inhibitors. They can also lead to problems during melt processing and fabrication steps, including degradation of molecular weight, cross-linking, or discoloration.

These attributes of typical additive compounds like mineral oils limit the performance of the final plasticized polyolefin, and therefore its usefulness in many applications. As a result, they are not highly desirable for use as modifiers for polyolefins.

There remains a need for an improved method of producing articles having an elastomeric portion and a thermoplastic portion, and for new ways of modifying the properties of the thermoplastic portion.

In a first aspect, the present invention provides a shaped structure comprising first and second members, in which the first member comprises an elastomeric material and the second member comprises a material which comprises a modifier and a thermoplastic polymer, wherein the modifier comprises carbon and hydrogen, and does not contain an appreciable extent of functional groups and has one or more of the following characteristics:

a. a pour point (ASTM D97) of −10° C. or less;

b. a Viscosity Index (VI) as measured by ASTM D2270 of 120 or more;

c. a flash point (ASTM D92) of 200° C. or more;

d. a specific gravity (ASTM D4052, 15.6/15.6° C.) of 0.88 or less.

The modifier improves the properties of the thermoplastic polymer and/or improves its processibility. Furthermore, because the modifier has a very low content of functional groups, many of the problems of the known plasticizers are avoided.

In a preferred embodiment, the modifier has c. a flash point (ASTM D92) of 200° C. or more, and one or more of:

a. a pour point (ASTM D97) of −10° C. or less;

b. a Viscosity Index (VI) as measured by ASTM D2270 of 120 or more;

d. a specific gravity (ASTM D4052, 15.6/15.6° C.) of 0.88 or less.

In an alternative preferred embodiment, the modifier has

b. a Viscosity Index (VI) as measured by ASTM D2270 of 120 or more; and

d. a specific gravity (ASTM D4052, 15.6/15.6° C.) of 0.88 or less.

The modifier is preferably a liquid modifier.

It will be realized that the classes of materials described herein that are useful as modifiers can be utilized alone or admixed with other modifiers described herein in order to obtain desired properties.

The modifier of the present invention is preferably a compound comprising carbon and hydrogen, and preferably does not contain an appreciable extent of functional groups selected from hydroxide, aryls and substituted aryls, halogens, oxygen-containing groups such as alkoxys, carboxylates, carboxyl, esters, acrylates and ethers, and nitrogen-containing groups such as amines. By “appreciable extent of functional groups”, it is meant that compounds comprising these groups are not deliberately added to the modifier, and if present at all, are present at less than 5 weight % (wt %) in one embodiment, more preferably less than 4 wt %, more preferably less than 3 wt %, more preferably less than 2 wt %, more preferably less than 1 wt %, more preferably less than 0.7 wt %, more preferably less than 0.5 wt %, more preferably less than 0.3 wt %, more preferably less than 0.1 wt %, more preferably less than 0.05 wt %, more preferably less than 0.01 wt %, more preferably less than 0.001 wt %, where wt % is based upon the weight of the modifier.

Preferably, the modifier has a total content of carbon and hydrogen, as determined by elemental analysis, of at least 95%, more preferably at least 96%, more preferably at least 97%, more preferably at least 98%, more preferably at least 99%, more preferably at least 99.3%, more preferably at least 99.9%, and more preferably at least 99.95% by weight.

In another embodiment, the modifier is a hydrocarbon that does not contain olefinic unsaturation to an appreciable extent. By “appreciable extent of olefinic unsaturation” it is meant that the carbons involved in olefinic bonds account for less than 10%, preferably less than 9%, more preferably less than 8%, more preferably less than 7%, more preferably less than 6%, more preferably less than 5%, more preferably less than 4%, more preferably less than 3%, more preferably less than 2%, more preferably less than 1%, more preferably less than 0.7%, more preferably less than 0.5%, more preferably less than 0.3%, more preferably less than 0.1%, more preferably less than 0.05%, more preferably less than 0.01%, more preferably less than 0.001%, of the total number of carbons. In some embodiments, the percent of carbons of the modifier involved in olefinic bonds is between 0.001 and 10% of the total number of carbon atoms in the modifier, preferably between 0.01 and 7%, preferably between 0.1 and 5%, more preferably less than 1%. Percent of carbons involved in olefinic bonds is determined by ¹H NMR spectroscopy.

In one embodiment, the modifier of the present invention comprises C₂₅ to C₁₅₀₀ paraffins, and C₃₀ to C₅₀₀ paraffins in another embodiment. In another embodiment, the modifier consists essentially of C₃₅ to C₃₀₀ paraffins, and consists essentially of C₄₀ to C₂₅₀ paraffins in another embodiment.

In one embodiment, the modifier of the present invention has a pour point (ASTM D97) of less than −10° C. in one embodiment, less than −20° C. in another embodiment, less than −30° C. in yet another embodiment, less than −40° C. in yet another embodiment, less than −50° C. in yet another embodiment, and less than −60° C. in yet another embodiment, and greater than −120° C. in yet another embodiment, and greater than −200° C. in yet another embodiment, wherein a desirable range may include any upper pour point limit with any lower pour point limit described herein.

Any modifier described herein may have a Viscosity Index (VI) as measured by ASTM D2270 of 90 or more, preferably 95 or more, more preferably 100 or more, more preferably 105 or more, more preferably 110 or more, more preferably 115 or more, more preferably 120 or more, more preferably 125 or more, more preferably 130 or more. In another embodiment the modifier has a VI between 90 and 400, preferably between 120 and 350.

In some embodiments, the modifier may have a kinematic viscosity at 100° C. (ASTM D445) of from 3 to 3000 cSt, and from 6 to 300 cSt in another embodiment, and from 6 to 200 cSt in another embodiment, and from 8 to 100 cSt in yet another embodiment, and from 4 to 50 cSt in yet another embodiment, and less than 50 cSt in yet another embodiment, and less than 25 cSt in yet another embodiment, wherein a desirable range may comprise any upper viscosity limit with any lower viscosity limit described herein.

In another embodiment any modifier described herein may have a flash point (ASTM D92) of 200° C. or more, preferably 210° or more, preferably 220° C. or more, preferably 230° C. or more, preferably 240° C. or more, preferably 245° C. or more, preferably 250° C. or more, preferably 260° C. or more, preferably 270° C. or more, preferably 280° C. or more. In another embodiment the modifier has a flash point between 200° C. and 300° C., preferably between 240° C. and 290° C.

Any modifier described herein may have a dielectric constant measured at 20° C. of less than 3.0 in one embodiment, and less than 2.8 in another embodiment, less than 2.5 in another embodiment, and less than 2.3 in yet another embodiment, and less than 2.1 in yet another embodiment. Polyethylene itself has a dielectric constant (1 kHz, 23° C.) of at least 2.3 according to the CRC HANDBOOK OF CHEMISTRY AND PHYSICS (David R. Lide, ed. 82^{d} ed. CRC Press 2001).

In some embodiments any modifier described herein may have a specific gravity (ASTM D4052, 15.6/15.6° C.) of less than 0.88 in one embodiment, and less than 0.87 in another embodiment, and less than 0.86 in another embodiment, and less than 0.85 in another embodiment, and from 0.80 to 0.87 in another embodiment, and from 0.81 to 0.86 in another embodiment, and from 0.82 to 0.85 in another embodiment, wherein a desirable range may comprise any upper specific gravity limit with any lower specific gravity limit described herein.

Any modifier described herein preferably has a low degree of color, such as typically identified as “water white”, “prime white”, “standard white”, or “bright and clear,” preferably an APHA color of 100 or less, preferably 80 or less, preferably 60 or less, preferably 40 or less, preferably 20 or less, as determined by ASTM D1209.

The modifier preferably has a number average molecular weight (Mₙ) of 21,000 g/mole or less in one embodiment, preferably 20,000 g/mole or less, preferably 19,000 g/mole or less, preferably 18,000 g/mole or less, preferably 16,000 g/mole or less, preferably 15,000 g/mole or less, preferably 13,000 g/mole or less and 10,000 g/mole or less in yet another embodiment, and 5,000 g/mole or less in yet another embodiment, and 3,000 g/mole or less in yet another embodiment, and 2,000 g/mole or less in yet another embodiment, and 1500 g/mole or less in yet another embodiment, and 1,000 g/mole or less in yet another embodiment, and 900 g/mole or less in yet another embodiment, and 800 g/mole or less in yet another embodiment, and 700 g/mole or less in yet another embodiment, and 600 g/mole or less in yet another embodiment, and 500 g/mole or less in yet another embodiment. Preferred minimum Mₙ is at least 200 g/mole, preferably at least 300 g/mole. Further a desirable molecular weight range can be any combination of any upper molecular weight limit with any lower molecular weight limit described above. Mₙ is determined using size exclusion chromatography in 1,2,4-trichlorobenzene stabilised with butylated hydroxytoluene on three Polymer Laboratories PLgel 10 mm Mixed-B columns with a differential refractive index detector, an online light scattering detector and a viscometer.

Certain mineral oils have been classified as Hydrocarbon Basestock Group I, II, or III by the American Petroleum Institute (API) according to the amount of saturates and sulfur they contain and their viscosity indices. Group I basestocks are solvent-refined mineral oils that contain the highest levels of unsaturates and sulfur, and low viscosity indices; they tend to define the bottom tier of lubricant performance. They are the least expensive to produce and currently account for the bulk of the “conventional” basestocks. Groups II and III basestocks are more highly refined (e.g., by hydroprocessing) than Group I basestocks, and often perform better in lubricant applications. Group II and III basestocks contain less unsaturates and sulfur than the Group I basestocks, while Group III basestocks have higher viscosity indices than the Group II basestocks do. Additional API basestock classifications, namely Groups IV and V, are also used in the basestock industry. Group IV basestocks include polyalphaolefins. The five basestock groups are described by Rudnick and Shubkin in Synthetic Lubricants and High-Performance Functional Fluids, Second edition (Marcel Dekker, Inc. New York, 1999). The modifier may be a group III or group IV basestock.

In a preferred embodiment, the modifier is a polyalphaolefin. As polyalphaolefin, there may advantageously be used an oligomer of an alphaolefin having from 5 to 14 carbon atoms, e.g., 1-pentene, 1-hexene, 1-heptene, 1-octene, 1-nonene, 1-decene, 1-undecene and 1-dodecene. Preferred oligomers are of alphaolefins having from 6 to 12, more preferred are those having from 8 to 12, carbon atoms, and most preferred are oligomers of the C₁₀ alphaolefin 1-decene. The alphaolefin may be branched or, preferably, linear. The materials may be, and usually are, mixtures of different oligomers (for example, dimers to octomers) of the same olefin, and they may be mixtures of oligomers of more than one olefin. The PAO may be hydrogenated, to remove all or substantially all residual double bonds.

Advantageously, the PAO has a number average molecular weight (Mₙ) within the range of from 100 to 21000, more advantageously from 200 to 10000, preferably from 200 to 7000, more preferably from 200 to 3000, and most preferably from 1500 to 3000. Advantageously, the PAO has a pour point below 0° C., more advantageously below −10° C., preferably below −20° C., more preferably below −40° C., and most preferably below −50° C. Preferably, the PAO's have a kinematic viscosity at 10° C. of 3 cSt or more, preferably 6 cSt or more, preferably 8 cSt or more, preferably 10 cSt or more, preferably 20 cSt or more, preferably 300 cSt or less, preferably 100 cSt or less. Advantageously, the PAO's have a kinematic viscosity at 100° C. of between 3 and 1000 cSt, preferably between 6 and 300 cSt, preferably between 8 and 100 cSt, preferably between 8 and 40 cSt.

Preferably, the PAO's have a Viscosity Index of 120 or more, preferably 130 or more, preferably 140 or more, preferably 150 or more, preferably 170 or more, preferably 200 or more, preferably 250 or more.

Preferably, the PAO's have a flash point of 200° C. or more, preferably 220° C. or more, preferably 240° C. or more, preferably between 260° C. and 290° C.

Examples of suitable commercially available PAO's are those in the Spectrasyn, SHF, and SuperSyn (trademarks) series of ExxonMobil Chemical Company. Other PAO materials available include those sold under the Synfluid trademark by Chevron Phillips Chemical Co, under the Durasyn trademark by BP Amoco Chemicals, under the Nexbase trademark by Fortum Oil and Gas, under the Synton trademark by Crompton Corporation, and under the Emery trademark by Cognis Corporation.

In another embodiment, the modifier is a hydrocarbon fluid with a branched paraffin:normal paraffin ratio ranging from about 0.5:1 to 9:1, preferably from about 1:1 to 4:1. The branched paraffins of the mixture contain greater than 50 wt % (based on the total weight of the branched paraffins) mono-methyl species, for example, 2-methyl, 3-methyl, 4-methyl, 5-methyl or the like, with minimum formation of branches with substituent groups of carbon number greater than 1, such as, for example, ethyl, propyl, butyl or the like; preferably, greater than 70 wt % of the branched paraffins are mono-methyl species. The paraffin mixture has a number-average carbon number (Cₙ) in the range of 20 to 500, preferably 30 to 400, preferably 40 to 200, preferably 25 to 150, preferably 30 to 100, more preferably 20 to 100, more preferably 20 to 70; has a kinematic viscosity at 100° C. ranging from 3 to 500 cSt, preferably 6 to 200 cSt, preferably 8 to 100 cSt, more preferably 6 to 25 cSt, more preferably 3 to 25 cSt, more preferably 3 to 15 cSt; and boils within a range of from 100 to 350° C., preferably within a range of from 110 to 320° C., preferably within a range of 150 to 300° C. In a preferred embodiment, the paraffinic mixture is derived from a Fischer-Tropsch process. These branch paraffin/n-paraffin blends are described in, for example, U.S. Pat. No. 5,906,727.

Thus, the modifier may comprise a wax isomerate lubricant oil basestock, which includes hydroisomerized waxy stocks (e.g. waxy stocks such as gas oils, slack waxes, fuels hydrocracker bottoms, etc.), hydroisomerized Fischer-Tropsch hydrocarbons and waxes, Gas-to-Liquids (GTL) base stocks and base oils, and other waxy feedstock derived hydroisomerized base stocks and base oils, or mixtures thereof. Fischer-Tropsch waxes, the high boiling point residues of Fischer-Tropsch synthesis, are highly paraffinic hydrocarbons with very low sulfur content, and are often preferred feedstocks in processes to make hydrocarbon fluids of lubricating viscosity.

The hydroprocessing used for the production of such base stocks may use an amorphous hydrocracking/hydroisomerization catalyst, such as one of the specialized lube hydrocracking catalysts or a crystalline hydrocracking/hydroisomerization catalyst, preferably a zeolitic catalyst. For example, one useful catalyst is ZSM-48 as described in U.S. Pat. No. 5,075,269. Processes for making hydrocracked/hydroisomerized distillates and hydrocracked/hydroisomerized waxes are described, for example, in U.S. Pat. Nos. 2,817,693; 4,975,177; 4,921,594 and 4,897,178 as well as in British Patent Nos. 1,429,494; 1,350,257; 1,440,230 and 1,390,359. Particularly favorable processes are described in European Patent Application Nos. 464546 and 464547. Processes using Fischer-Tropsch wax feeds are described in U.S. Pat. Nos. 4,594,172 and 4,943,672.

Gas-to-Liquids (GTL) base stocks and base oils, Fischer-Tropsch hydrocarbon derived base stocks and base oils, and other waxy feedstock derived base stocks and base oils (or wax isomerates) that can be advantageously used in the present invention have a kinematic viscosities at 100° C. of about 3 cSt to about 500 cSt, preferably about 6 cSt to about 200 cSt, preferably about 8 cSt to about 100 cSt, more preferably about 3 cSt to about 25 cSt. These Gas-to-Liquids (GTL) base stocks and base oils, Fischer-Tropsch hydrocarbon derived base stocks and base oils, and other waxy feedstock derived base stocks and base oils (or wax isomerates) have pour points (preferably less than −10° C., preferably about −15° C. or lower, preferably about −25° C. or lower, preferably −30° C. to about −40° C. or lower); have a high viscosity index (preferably 110 or greater, preferably 120 or greater, preferably 130 or greater, preferably 150 or greater); and are typically of high purity (high saturates levels, low-to-nil sulfur content, low-to-nil nitrogen content, low-to-nil aromatics content, low bromine number, low iodine number, and high aniline point). Useful compositions of Gas-to-Liquids (GTL) base stocks and base oils, Fischer-Tropsch hydrocarbon derived base stocks and base oils, and wax isomerate hydroisomerized base stocks and base oils are recited in U.S. Pat. Nos. 6,080,301; 6,090,989, and 6,165,949 for example, and are incorporated herein in their entirety by reference.

The modifier may comprise a Group III hydrocarbon basestock, for example, a severely hydrotreated mineral oil having a saturates levels of 90% or more, preferably 92% or more, preferably 94% or more, preferably 95% or more. Preferably, the Group III basestock has a sulfur content of less than 0.03%, preferably between 0.001 and 0.01%. Preferably, the Group III basestock has a VI in excess of 120, preferably 130 or more. Preferably the Group III hydrocarbon base stock has a kinematic viscosity at 100° C. of 3 to 100, preferably 4 to 100 cSt, preferably 6 to 50 cSt, preferably 8 to 20; and/or a number average molecular weight of 300 to 5,000, preferably 400 to 2,000, more preferably 500 to 1,000; and/or a carbon number of 20 to 400, preferably 25 to 400, preferably 35 to 150, more preferably 40 to 100. Preferably the Group III basestock has a pour point of −10° C. or less. Advantagously, the Group III basestock has a flash point of 200° C. or more.

Preferably, the modifier is not an oligomer or polymer of C₄ olefin(s) (including all isomers, e.g. n-butene, 2-butene, isobutylene, and butadiene, and mixtures thereof). Such materials, which are referred to as “polybutene” liquids (or “polybutenes”) when the oligomers comprise isobutylene and/or 1-butene and/or 2-butene, are commonly used as additives for polyolefins; e.g. to introduce tack or as a processing aid. The ratio of C₄ olefin isomers can vary by manufacturer and by grade, and the material may or may not be hydrogenated after synthesis. Commercial sources of polybutenes include BP (Indopol grades) and Infineum (C-Series grades). When the C₄ olefin is exclusively isobutylene, the material is referred to as “polyisobutylene” or PIB. Commercial sources of PIB include Texas Petrochemical (TPC Enhanced PIB grades). When the C₄ olefin is exclusively 1-butene, the material is referred to as “poly-n-butene” or PNB.

Optionally, the modifier is not an oligomer or polymer of C4 olefin(s); however, an oligomer or polymer of C₄ olefin(s) (including all isomers, e.g. n-butene, 2-butene, isobutylene, and butadiene, and mixtures thereof) may be present in the composition. In a preferred embodiment, the composition comprises less than 50 wt % (preferably less than 40%, preferably less than 30 wt %, preferably less than 20 wt %, more preferably less than 10 wt %, more preferably less than 5 wt %, more preferably less than 1 wt %, preferably 0 wt %) polymer or oligomer of C₄ olefin(s) such as PIB, polybutene, or PNB, based upon the weight of the composition.

In a preferred embodiment, the modifier contains less than 50 weight % of C₄ olefin(s), preferably isobutylene, based upon the weight of the modifier. Preferably the modifier contains less than 45 weight %, preferably less than 40 wt %, preferably less than 35 wt %, preferably less than 30 wt %, preferably less than 25 wt %, preferably less than 20 wt %, preferably less than 15 wt %, preferably less than 10 wt %, preferably 5 wt %, preferably less than 4 wt %, preferably less than 3%, preferably less than 2%, preferably less than 1 wt %, preferably less than 0.5 wt %, preferably less than 0.25 wt % of C₄ olefin(s), preferably isobutylene, based upon the weight of the modifier.

Accordingly, the modifier is preferably:

i) a polyalphaolefin;

ii) a hydrocarbon fluid with a branched paraffin:normal paraffin ratio ranging from 0.5:1 to 9:1;

iii) a wax isomerate lubricant oil basestock;

iv) a Gas-to-Liquids basestock or base oil or a Fischer-Tropsch hydrocarbon derived basestock or base oil; or

v) a Group III hydrocarbon basestock.

i), iv) and v) are particularly preferred.

The elastomeric material of the first member may be any natural or synthetic elastomeric material, with synthetic materials being preferred. Examples of elastomeric materials include compounded and non-compounded elastomers and crosslinked (vulcanized) or noncrosslinked elastomers, including thermoplastic elastomers (TPEs), whether crosslinked or uncrosslinked.

The elastomeric material will typically include one or more elastomeric polymers. Examples of preferred elastomeric polymers include, but are not limited to, ethylene/propylene rubber (EPR), ethylene/propylene/diene monomer rubber (EPDM), styrenic block copolymer rubbers (including SEBS, SI, SIS, SB, SBS, SIBS and the like, where S=styrene, EB=random ethylene+butene, I=isoprene, and B=butadiene), butyl rubber, halobutyl rubber, copolymers of isobutylene and para-alkylstyrene, halogenated copolymers of isobutylene and para-alkylstyrene, natural rubber, polyisoprene, copolymers of butadiene with acrylonitrile, polychloroprene, alkyl acrylate rubber, chlorinated isoprene rubber, acrylonitrile chlorinated isoprene rubber, polybutadiene rubber (both cis and trans).

The elastomeric polymer may be an ethylene/alphaolefin copolymer. Such copolymers include those sold by ExxonMobil Chemical Company under the name EXACT™ and are referred to as plastomers.

Especially preferred elastomers are ethylene/propylene/diene monomer (EPDM), ethylene/propylene (EPR), and blends of EPR and EPDM elastomers.

Especially suitable elastomers are thermoplastic elastomers, which may be, for example, Thermoplastic Elastomers Vulcanizate (TPE-V), or materials comprising a thermoplastic polymer, e.g., an olefin polymer and a vulcanizable rubber, especially one that is vulcanizable during formation of the composition in the melt (dynamically vulcanizable). Examples of other suitable rubbers for use in the thermoplastic elastomers are styrene-butadiene (SBR), butadiene-acrylonitrile (NBR) isobutene-isoprene (IIR), and butadiene (BR).

The term “dynamic vulcanization” is herein intended to include a vulcanization process in which an engineering resin and a vulcanizable elastomer are vulcanized under conditions of high shear. As a result, the vulcanizable elastomer is simultaneously cross-linked and dispersed as fine particles of a “micro gel” within the engineering resin. Procedures for dynamically vulcanizing materials are disclosed in U.S. Pat. No. 6,013,727, Col. 2, line 57-Col. 3, line 5, Col. 11, line 4-Col. 13, line 63 and the examples therein. Examples of TPEs are disclosed in U.S. Pat. No. 6,147,180, at Col. 1, lines 17-Col. 2, line 30, and Col. 3, line 3-Col. 8, line 5 and the examples therein.

Other suitable types of thermoplastic elastomers are TPE-S (styrene-containing block copolymers, e.g., styrene-butadiene styrene (SBS), styrene ethylene/butadiene styrene (SEBS) and styrene-isoprene-styrene (SIPS) block copolymers), TPE-O (polyolefin based, non-vulcanized), TPE-U (polyurethane), TPE-A (polyamide based) and TPE-E (polyester based). For a weatherseal, the most preferred material is TPE-V. TPE-A is suitable for use in, for example, automobile hoses. TPE-E is preferred for use in automotive gaiters and boots.

Preferably, the elastomeric polymer has a density of 0.90 g/cm³ or less, more preferably 0.85 g/cm³ or less. Preferably, the elastomeric polymer has a crystallinity of less than 40%.

Advantageously, the thermoplastic polymer is a crystalline thermoplastic polymer. Preferably, the thermoplastic polymer has a degree of crystallinity of at least 40%, preferably at least 50%.

In a preferred embodiment the thermoplastic polymer of the second member is non-elastomeric. For example, the thermoplastic polymer may be selected from polyolefins, polyamides, polyesters, polycarbonates, polysulfones, polyacetals, polylactones, acrylonitrile-butadiene-styrene resins, polyphenylene oxide, polyphenylene sulphide, styrene-acrylonitrile resins, styrene maleic anhydride, polyimides, aromatic polyketones, or mixtures of two or more of the above. Preferred polyolefins include, but are not limited to, polymers comprising one or more linear, branched or cyclic C2 to C40 olefins, preferably polymers comprising ethylene copolymerized with one or more C3 to C40 olefins, preferably a C3 to C20 alpha olefin, more preferably C3 to C10 alpha-olefins.

The thermoplastic polymer is advantageously polyethylene, including low density polyethylene and high density polyethylene. Preferably, the thermoplastic polymer is high density polyethylene (HDPE). For processing reasons, the HDPE may be blended with an ethylene copolymer such as a copolymer of ethylene and butene, hexene and/or octene. The ethylene copolymers known as plastomers are especially suitable. In one embodiment therefore, the second member comprises a polymer blend such as a blend of high density polyethylene and an ethylene copolymer, particularly a plastomer comprising butene, hexene or octene-derived units. Advantageously, the HPDE/copolymer blend comprises from 5 to 50 wt %, preferably from 10 to 30 wt % of the copolymer.

The melt index (2.16 kg, 190° C.) of the polyethylene is preferably less than 10 g/10 min, more preferably less than 7 g/min, yet more preferably less than 1 g/min. Optionally, the MI of the thermoplastic polymer is at least 0.01 g/min or greater.

The number average molecular weight (Mₙ) as determined by GPC is preferably at least 40,000, more preferably at least 50,000, and yet more preferably at least 60,000. Optionally, the Mₙ of the polyethylene as determined by GPC is 150,000 or less.

The intrinsic viscosity of the polyethylene (measured in decalin at 135° C.) is preferably in the range of from 1.0 to 6.0 dl/g, and is more preferably in the range of from 1 to 4 dl/g.

For purposes of this invention and the claims thereto, an ethylene polymer having a density of 9.86 g·cm³ or less is referred to as an ethylene elastomer or elastomer, an ethylene polymer having a density of more than 0.86 to less than 0.910 g/cm³ is referred to as an ethylene plastomer or plastomer; an ethylene polymer having a density of 0.910 to 0.940 g/cm³ is referred to as a low density polyethylene (LDPE) (LDPE includes linear low density polyethylene “LLDPE” which refers to ethylene polymers in this density range made using a heterogeneous catalyst, as well as ethylene polymers in this density range made in a high pressure process using a free radical catalyst); and an ethylene polymer having a density of more than 0.940 g/cm³ is referred to as a high density polyethylene (HDPE). Density is measured by density-gradient column, as described is ASTM D1505, on a compression-molded specimen that has been slowly cooled to room temperature (i.e., over a period of 10 minutes or more) and allowed to age for a sufficient time that the density is constant within +/−0.001 g/cm³. The units for density are g/cm³.

Another preferred polyolefin is polypropylene.

The materials of the first and second members may differ, for example, by including polymers of different monomer composition. The polymers may also be of the some monomer composition but differing in, for example, molecular weight, or degree of branching. The invention is, however, especially applicable where the materials of the first and second members comprise polymers of different categories, for example, the first member comprises an elastomeric polymer and the second member comprises a non-elastomeric thermoplastic polymer, especially a crystalline thermoplastic polymer.

The modifier may be used, for example, in a proportion of up to 30% by weight, based on the weight of the thermoplastic polymer, advantageously in a range of from 1% to 20%, more advantageously 2% to 10%, and preferably from 2 to 5%. The modifier may be used alone or in combination with one or more plasticizers, especially a plasticizing polymer, for example a low molecular weight polyethylene or ethylene copolymer, e.g., an ethylene α-olefin copolymer, e.g., one mentioned above. Unlike certain mineral oil plasticizers, the modifier does not migrate to the surface, or bleed out, in processing or use.

Other plasticizers may, however, be present, for example, the phthalate, adipate, and trimellitate esters of alkanols, especially alkanols of from four to twelve carbon atoms, commonly used to plasticize polymers may be used, provided that in the polymer concerned they do not bleed out.

Other additives, especially those typically used in the art or described in the literature, may be present in the materials of either or both members of the shaped structure of the invention, for example, processing aids, antioxidants, stabilizers, anticorrosion agents, UV absorbers, antistatics, slip agents, pigments, dyes and other colorants, and fillers. Where the material is to be crosslinked, crosslinking agents appropriate to the material and the crosslinking method may be incorporated.

The material of the first member may also include a modifier, which may be the same as or different to the modifier of the second member. (In some instances, modifiers may migrate over time from the material of the second member to the material of the first member). Where the material of the first member includes a modifier, that modifier may have any of the features and characteristics mentioned above in relation to the modifier of the second member. It is believed that inclusion of modifiers in both the first and in the second members improves the adhesion between those members.

The composite article comprising the first and second members is preferably formed by a process in which the first and second materials are brought together in a molten state, for example, by co-extrusion (in which case, if the first member comprises a crosslinked elastomer, crosslinking is advantageously effected continuously after extrusion in a hot air tunnel, microwave oven, salt bath or hot fluid bed). The process of making the shaped structure may involve thermoforming, molding, two-step co-extrusion, post-overforming on a cured elastomeric material, or dual injection in a mold.

In one embodiment, the first and second members are in contact.

It is often desirable, for example in an automobile weatherseal, to have a structure primarily of an elastomeric material of which at least part has a surface with a coefficient of friction lower than that of the elastomeric material itself. Such has been achieved in the past by coating the pre-formed elastomer with flock, applying a complex thermocurable resin composition, e.g., of silicone and/or polyurethane, and/or fluorocarbon elastomer or by co-extruding the elastomer with a thermoplastic resin composition. Difficulties have been encountered with the last-mentioned proposal, because the thermoplastic of choice, a high density polyethylene, has a high melt viscosity and also a higher crystalline melting point, and hence a higher extrusion temperature, than the elastomer, and also a higher thermal expansion coefficient.

It has been proposed to overcome these problems by blending the polyethylene with a plasticizing polymer, for example, one having a peak melting temperature by DSC in the range 50 to 120° C., e.g., an ethylene/butene, ethylene/hexene, or ethylene/octene copolymer, which requires a high shear mixer for compounding. There therefore remains a need to reduce the melt viscosity and the possible co-extrusion temperature further.

It has now been found that by incorporating a modifier in the thermoplastic material its crystallization temperature and melt viscosity are reduced and co-extrusion with the elastomeric material facilitated.

The important characteristic of low friction coefficient is retained, as are the scratch and abrasion resistances.

The composite article may therefore be an automobile weatherseal. Advantageously, the weatherseal comprises as first member an elastomeric substrate and as second member a surface layer of a crystalline thermoplastic polymer, at least the surface layer containing a modifier, preferably a polyalphaolefin. The crystalline polymer is advantageously polyethylene, especially a high density polyethylene.

Accordingly, in an advantageous embodiment, when measured as described in the Example below, the static and dynamic coefficients of friction of the modifier-containing member(s) are both at most 0.4, advantageously both at most 0.3.

The thickness of the first member, the substrate, of the composite article, especially when it is a weatherseal, may be of the order of 0.1 mm to 100 mm, especially 1 mm to 10 mm, while that of the second member, the surface layer, may be of the order of 10 μm to 10000 μm, especially from 30 μm to 500 μm.

The applications of the composite articles of the invention include all those where the properties or characteristics of one member differ from those of another, either in manufacture or use.

As examples there may be mentioned as applications electrical apparatus, e.g., wire and cable, building and construction seals, e.g., in windows, concrete slabs and pipes, toys, sporting equipment, medical devices, outdoor furniture and automotive components. As examples of the latter, there may be mentioned bumpers, grills, interior and exterior trims, dashboard and instrument panels, spoilers, door and hood components, hoses, mirror housings, and especially weatherseals, for example glass run channels, door seals, belt line seals, insulation seals, roof seals, trunk seals, hood seals. Other seals in automotive applications include those used to insulate parts from air, water, dust, and vibration, and interiors from noise and vibration. Other automotive applications include hoses, pipes, tubes and windscreen wipers.

### Test Method

Melting point (Tm), peak crystallization temperature (Tc), heat of fusion (Hf) and percent crystallinity are determined using the following procedure according to ASTM E 794-85. Differential scanning calorimetric (DSC) data is obtained using a TA Instruments 2910 machine or a Perkin-Elmer DSC 7 machine. In the event that the TA Instruments 2910 machine and the Perkin-Elder DSC 7 machine produce different DSC data, the data from the TA Instruments model 2910 shall be used. Samples weighing approximately 5-10 mg are sealed in aluminium sample pans. The DSC data is recorded by first cooling the sample to −50° C. and then gradually heating it to 200° C. at a rate of 10° C. per minute. The sample is kept at 200° C. for 5 minutes before a second cooling-heating cycle is applied. Both the first and second cycle thermal events are recorded. Areas under the melting curves are measured and used to determine the heat of fusion and the degree of crystallinity. The percent crystallinity (X5) is calculated using the formula, X %=[area under the curve (Joules/gram)/B (Joules/gram]*100, where B is the heat of fusion for the homopolymer of the major monomer component. These values for B area to be obtained from the Polymer Handbook, Fourth Edition, published by John Wiley and Sons, New York 1999. A value of 189 J/g (B) is used as the heat of fusion for 100% crystalline polypropylene. A value of 290 J/g is used for the equilibrium heat of fusion for 100% crystalline polyethylene. For semi-crystalline polymers, having appreciable crystallinity, the melting temperature is measured and reported during the second heating cycle. For semi-amorphous polymers, having comparatively low levels of crystallinity, the melting temperature is measured and reported during the first heating cycle. Prior to the DSC measurement, the sample is aged (typically by holding it at ambient temperature for a period up to about 5 days) or annealed to maximize the level of crystallinity.

The following example, in which all parts and percentages are by weight, illustrates the invention:

### EXAMPLE

In this example a thermoplastic material suitable for use as a slip coat in a weatherseal and including a modifier was prepared and its rheometry was compared to a similar material not comprising a modifier.

A composition comprising 80 parts high density polyethylene (Escorene® available from ExxonMobil Chemical, grade HYA 010 HD, melt index 0.07 g/10 minutes under 2.16 kg, density 0.952 and Vicat softening point 129° C.), 17 parts of ethylene/octene plastomer (Exact® grade 5371, melt index 5.0 g/10 minutes under 2.16 kg, density 0.870 and peak melting temperature 64° C.), and 3 parts polyalphaolefin (Spectrasyng 40, viscosity 41 cSt at 100° C., VI 147, pour point −36° C., flash point 281° C.) as modifier was mixed under high shear and pressure to ensure full homogeneity and subjected to rheometric testing in the melting temperature range. For comparison a composition containing 80 parts of the same high density polyethylene (Escorene® HYA 010 HD) and 20 parts of the same ethylene/octene copolymer (Exact® 5371) was used. The rheometer used was the Rubber Process Analyser from Alpha Technology, in decreasing temperature mode to simulate a co-extrusion process.

In the manufacture of a weatherseal, the thermoplastic slipcoat material is melted and extruded at a high temperature, e.g., up to 240° C. in a plastic extruder, then conveyed to a common die of a rubber type extruder head containing the elastomeric thermosetting substrate, (maintained at a temperature of at most 130° C., advantageously at most 115° C., to prevent scorch) and the two materials are co-extruded. The rheometer used in the present experiment was set up to reproduce the temperature transition between that of a thermoplastic extruder (230° C.) and a rubber extruder (115° C.). The experiment was carried out at a high deformation rate of 200 rad/s, 14% strain to reproduce the actual stress condition encountered in a co-extrusion process. The results are shown in Table 1 below.

TABLE 1

Viscosity, kPa · s

| Temp ° C. | Invention | Comparison |
|---|---|---|
| 230 | 0.85 | 0.86 |
| 150 | 1.52 | 1.52 |
| 140 | 1.75 | 1.70 |
| 130 | 2.14 | 2.17 |
| 120 | 3.77 | 5.58 |
| 115 | 6.6 | 9.7 |
| 110 | 11.0 | 13.7 |
| 105 | 12.5 | 13.6 |
| 100 | 13.9 | 15.5 |
| 95 | 15.0 | 19.1 |
| 90 | 16.5 | 20.8 |

The results show that the composition containing polyalphaolefin has a lower melt viscosity and recrystallization temperature, which allow a lower extrusion temperature. In the co-extrusion of a slipcoat on an elastomeric material, it is therefore expected that the inclusion of a polyalphaolefin in the slipcoat would result in a smooth flow over the elastomeric material. Deformation under cooling caused by a difference in the thermal expansion coefficients of the two materials would thereby be reduced and excellent adhesion and consistent layer thickness would be achieved.

The dynamic and static friction coefficients of the example and comparison compositions were measured at room temperature (25° C.) in a “Peel-Friction Tester” from Thwing-Albert Co., the dynamic coefficient being measured by moving a sled carrying the sample over a glass surface, with the surface layer in contact with the glass. The sled speed was set at 250 mm/min, the sled weight being 1 kg. The results are shown in Table 2 below.

TABLE 2

| | Invention | Comparison |
|---|---|---|
| Dynamic | 0.23 | 0.28 |
| Static | 0.27 | 0.25 |

The results demonstrate that the use of a polyalphaolefin in an extrusible thermoplastic slipcoat improves processing performance, facilitating coextrusion with a thermosetting or a thermoplastic elastomer without detriment to the frictional properties. The sliding force in a weatherseal is therefore expected to remain low and the abrasion resistance under cycling glass wear is expected to be similar to that of the comparison composition.

1. A composite article comprising first and second members in which the first member comprises an elastomeric material and the second member comprises a material which comprises a modifier and a thermoplastic polymer, wherein the modifier comprises carbon and hydrogen, does not contain an appreciable extent of functional groups and has one or more of the following characteristics:
a. a pour point (ASTM D97) of −10° C. or less;
b. a Viscosity Index (VI) as measured by ASTM D2270 of 120 or more;
c. a flash point (ASTM D92) of 200° C. or more;
d. a specific gravity (ASTM D4052, 15.6/15.6° C.) of 0.88 or less.

2. The article of claim 1, wherein the modifier has c. a flash point (ASTM D92) of 200° C. or more, and one or more of:
a. a pour point (ASTM D97) of −10° C. or less;
b. a Viscosity Index (VI) as measured by ASTM D2270 of 120 or more;
d. a specific gravity (ASTM D4052, 15.6/15.6° C.) of 0.88 or less.

3. The article of claim 1, wherein the modifier has:
a Viscosity Index (VI) as measured by ASTM D2270 of 120 or more; and
a specific gravity (ASTM D4052, 15.6/15.6° C.) of 0.88 or less.

4. The article of claim 1, wherein the modifier comprises one or more of:
i) a polyalphaolefin;
ii) a hydrocarbon fluid with a branched paraffin:normal paraffin ratio ranging from 0.5:1 to 9:1;
iii) a Group III hydrocarbon basestock;
iv) a basestock derived from a Fischer-Tropsch hydrocarbon product.

5. The article of claim 1 in which the modifier is a polyalpholefin.

6. The article of claim 1, wherein the first member is a substrate and the second member is an outer layer on at least part of the surface of the substrate.

7. The article of claim 6 in which the substrate and outer layer are co-extruded.

8. The article of claim 1, wherein the first member comprises an ethylene/propylene/diene rubber (EPDM) or a thermoplastic elastomer (TPE).

9. The article of claim 8, in which the EPDM comprises propylene, from 0 to 5 weight % of a diene, and from 2 wt % to 25 wt % ethylene.

10. The article of claim 8, in which the TPE comprises a thermoplastic olefin polymer and an elastomeric ethylene copolymer.

11. The article of claim 10, in which the TPE is a vulcanizate.

12. A The article of claim 1, wherein the thermoplastic polymer of the second member is polyethylene.

13. The article of claim 1 in which the elastomeric material of the first member also comprises a modifier as defined in claim 1.

14. A weatherseal comprising the article claim 1.

15. The weatherseal of claim 14, wherein the coefficient of friction between the modifier-containing layer and glass, as measured using a Peel-Friction Tester from Thwing-Albert Co., is at most 0.4.

16. A process of manufacturing an article comprising a first member comprising an elastomeric material and a second member comprising a thermoplastic polymer, which comprises the step of including a modifier as defined in claim 1 in the second member.

17. The process of claim 16 in which the first and second members are co-extruded.

18. (canceled)
